(19) United States
(12) Patent Application Publication
(10) Pub. No.: US 2025/0353469 A1
(43) Pub. Date: Nov. 20, 2025

(54) Triple Blade Windshield Wiper

(71) Applicant: David Bradford, Grande Prairie (CA)

(72) Inventor: David Bradford, Grande Prairie (CA)

(21) Appl. No.: 18/667,723

(22) Filed: May 17, 2024

(51) Int. Cl. B60S 1/38

(52) U.S. Cl. CPC B60S 1/38; B60S 2001/3812; B60S 2001/3831; B60S 2001/3839

(57) ABSTRACT

A windshield wiper is disclosed herein. The windshield wiper includes a first longitudinal flexible blade member, a second longitudinal flexible blade member and a longitudinal scrubbing member sandwiched between the first longitudinal flexible blade member and the second longitudinal flexible blade member. In some versions, the longitudinal scrubbing member includes a textured outer surface. The windshield wiper is able to squeegee loose debris, such as rain and snow, as well as stuck-on debris, such as stuck on insects and dirt.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

The present invention relates generally to the field of windshield wipers of existing art and more specifically relates to a triple bladed windshield wiper for clearing liquid and solid debris, such as rain, snow and insects, from a windshield.

Windshield wipers are crucial components of any vehicle, designed to enhance visibility during adverse weather conditions. Constructed from a combination of rubber, metal, and plastic, windshield wipers are engineered to sweep across the windshield, clearing away rain, snow, or other liquid debris. At the core of their design lies the blade, typically made from a material such as silicone or natural rubber, which provides the necessary flexibility and resilience to conform to the glass surface of the windshield while efficiently removing moisture.

Despite the effectiveness of current windshield wipers in clearing liquid debris, windshield wipers in the current art tend to struggle with more solid or stuck-on debris; particularly, insects and stuck on residue therefrom. During certain seasons or in specific regions, insects frequently collide with the windshield of moving vehicles, leaving behind stubborn remnants that prove challenging for conventional windshield wipers to effectively eliminate.

The design of current windshield wipers contributes to this ineffectiveness, as they typically consist of either a single or double rubber blade having a smooth and flat surface, which is not effective in scrubbing the windshield. Therefore, whilst this design efficiently clears away rain and light debris, it struggles to tackle the more tenacious residue left by squashed insects. As a result, drivers frequently encounter smeared insect remains obstructing their view. Accordingly, a suitable solution is desired.

### SUMMARY OF THE INVENTION

In view of the foregoing disadvantages inherent in the known windshield wiper art, the present disclosure provides a novel triple blade windshield wiper. The general purpose of the present disclosure, which will be described subsequently in greater detail, is to provide a windshield wiper including a triple blade design that is effective in removing not only liquid, semi-liquid debris or loose debris, such as rain and snow; but also is effective in removing solid and/or stuck-on debris, such as insects and their residue.

A windshield wiper is disclosed herein. According to one or more embodiments, the windshield wiper may include a wiper arm mount, a longitudinal mounting member, first and second longitudinal flexible blade members and a longitudinal scrubbing member. The wiper arm mount may include at least one arm mounting member attached at a top side of the wiper arm mount and configured to attach the wiper arm mount to a wiper arm of a windshield; and at least one blade mounting member attached at a bottom side of the wiper arm mount. The longitudinal mounting member may be configured to attach to the wiper arm mount via the at least one blade mounting member.

The first and second longitudinal flexible blade members may extend downwardly from respective sides of the longitudinal mounting member and together are operative to remove loose debris from the windshield. A longitudinal channel may be defined between the first and second longitudinal flexible blade members and the longitudinal scrubbing member may be sized for placement in the longitudinal channel between the first flexible blade member and the second flexible blade member and oriented parallel therewith. The longitudinal scrubbing member operative to remove stuck-on debris from the windshield. According to some embodiments, the longitudinal scrubbing member may include a textured mesh outer surface operative to remove stuck-on debris from the windshield.

According to another embodiment, a windshield wiper refill is disclosed herein. According to one or more embodiments, the windshield wiper refill may include a longitudinal mounting member configured to attach to a wiper arm mount; first and second longitudinal flexible blade members; and a longitudinal scrubbing member. The first and second longitudinal flexible blade members may extend downwardly from respective sides of the longitudinal mounting member and each of the first and second longitudinal flexible blade members may include a planar top side, a curved blade member first side opposite a curved blade member second side and each tapering into a tip for ‘squeegeeing’ loose debris from a windshield.

A longitudinal channel may be defined between the curved blade member second side of the first longitudinal flexible blade member and the curved blade member first side of the second longitudinal flexible blade member. The longitudinal scrubbing member may be sized for placement in the longitudinal channel between the first flexible blade member and the second flexible blade member and oriented parallel therewith. A width of the longitudinal scrubbing member may be greater than a width of the first and second longitudinal flexible blade members.

The longitudinal scrubbing member may include a curved scrubbing member first side able to conform to an inner surface of the curved blade member second side of the first longitudinal flexible blade member and a curved scrubbing member second side able to conform to an inner surface of the curved blade member first side of the second longitudinal flexible blade. Further, the longitudinal scrubbing member may include a textured mesh outer surface operative to remove stuck-on debris from the windshield.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF FIGURES

The figures which accompany the written portion of this specification illustrate embodiments and methods of use for the present disclosure, a triple blade windshield wiper, constructed and operative according to the teachings of the present disclosure.

FIG. 1 is a front perspective view of a pair of windshield wipers attached about a windshield of a vehicle, according to an embodiment of the disclosure.

FIG. 2 is a detailed view of a windshield wiper being used on the windshield of the vehicle, according to an embodiment of the present disclosure.

FIG. 3 is a side perspective view of the windshield wiper including a wiper arm mount, a longitudinal mounting member, first and second longitudinal flexible blade members and a longitudinal scrubbing member, according to an embodiment of the present disclosure.

FIG. 4 is a perspective view of the longitudinal mounting member, the first and second longitudinal flexible blade members and the longitudinal scrubbing member, the longitudinal scrubbing member shown removed from a longitudinal channel defined between the first and second longitudinal flexible blade members, according to an embodiment of the present disclosure.

FIG. 5 is an exploded view of the longitudinal mounting member, the first and second longitudinal flexible blade members and the longitudinal scrubbing member, according to an embodiment of the present disclosure.

FIG. 6 is a cross-section view of the longitudinal mounting member, the first and second longitudinal flexible blade members and the longitudinal scrubbing member taken form line 6-6 in FIG. 3, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to windshield wipers and more particularly to a triple blade windshield wiper. Generally, the triple blade windshield wiper may include a pair of streak-free wiper blades and a third scrubber blade sandwiched between the pair of standard streak-free wiper blades. As such, the triple blade windshield wiper will squeegee loose debris, liquids and semi-liquids, such as rain and snow; and stuck-on or solid debris, such as stuck on insects and residue, from a windshield.

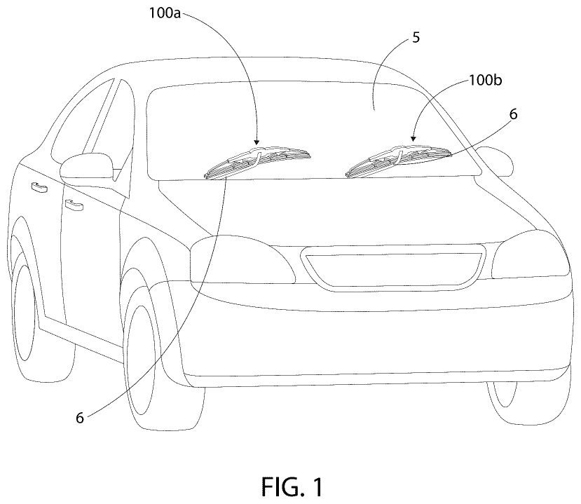

Referring now more specifically to the drawings by numerals of reference, there is shown in FIGS. 1-6, various views of a windshield wiper 100, according to one or more embodiments of the present disclosure.

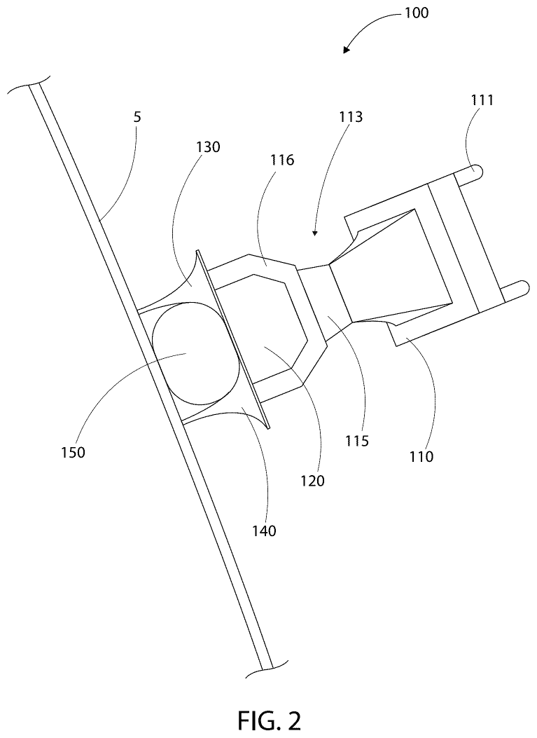

Referring first to FIGS. 1-2, there is shown in FIG. 1 a pair of windshield wipers 100a, 100b attached to a vehicle, according to one or more embodiments of the present disclosure; and in FIG. 2 there is shown a close-up detailed view of a windshield wiper 100 contacting a windshield 5 of the vehicle.

As shown in FIG. 1 and FIG. 2, the windshield wiper 100 may include a wiper arm mount 110. The wiper arm mount 110 may include at least one arm mounting member 111 attached at a top side 112 of the wiper arm mount 110 configured to attach the wiper arm mount 110 to a windshield wiper arm 6 on the vehicle, thereby enabling use of the windshield wiper 100. Further, as shown in FIG. 2 in particular, the windshield wiper 100 may further include a longitudinal mounting member 120, a first longitudinal flexible blade member 130, a second longitudinal flexible blade member 140 and a longitudinal scrubbing member 150.

As shown here, the longitudinal scrubbing member 150 may be attached in between the first longitudinal flexible blade member 130 and the second longitudinal flexible blade member 140. The first longitudinal flexible blade member 130 and the second longitudinal flexible blade member 140 may include a flexible tip that enables squeegeeing of the windshield 5. Particularly, the first and second longitudinal flexible blade members 130, 140, as above, may be particularly useful for removing loose debris, liquids and semi-liquids from the windshield 5, such as rain, snow and other lighter debris. It should however be appreciated that the first and second longitudinal flexible blade members 130, 140 are not limited to the removal of solely loose debris, liquids and semi-liquids. The first and second longitudinal flexible blade members 130, 140 are contemplated for use in removing debris that is of a low viscosity and/or low adherence properties.

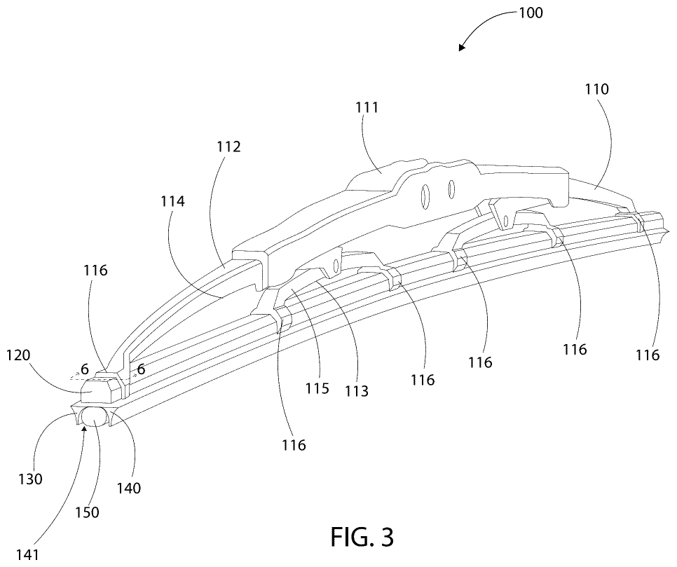

Referring now to FIG. 3, illustrating a side perspective view of the windshield wiper 100, according to one or more embodiments of the present disclosure. The windshield wiper 100 is shown here assembled and including the wiper arm mount 110, the longitudinal mounting member 120, the first longitudinal flexible blade member 130, the second longitudinal flexible blade member 140 and the longitudinal scrubbing member 150.

As shown here, at least one blade mounting member 113 may be attached at a bottom side 114 of the wiper arm mount 110 and configured to attach to the longitudinal mounting member 120. Particularly, in some embodiments, the at least one blade mounting member 113 may include a plurality of mounting members 113 spaced apart along a length of the wiper arm mount 110. In some embodiments, the plurality of mounting members 113 may include clips 116 configured to grip the longitudinal mounting member 120. Further, in some embodiments, the plurality of mounting members 113 may include arms 115, some of which include the clips 116 at an end thereof.

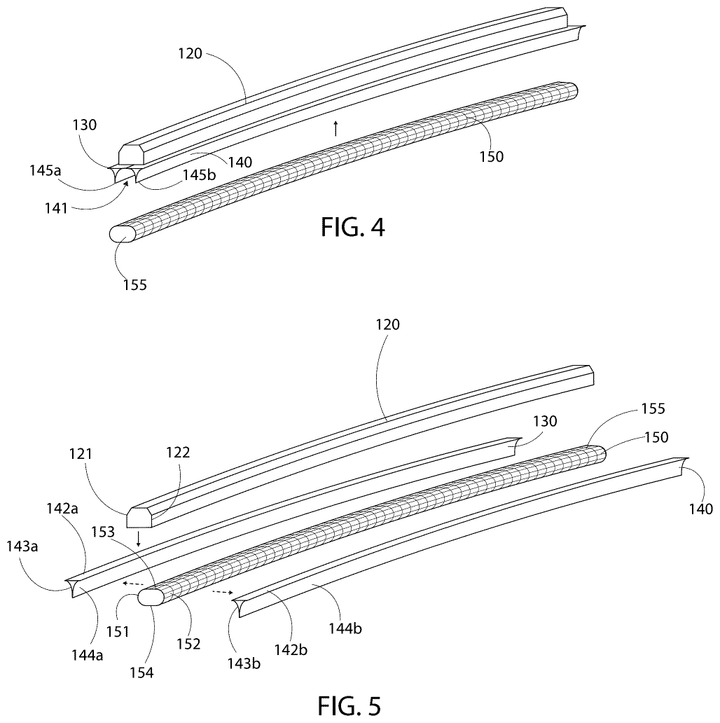

In some embodiments, the longitudinal mounting member 120 may include a generally irregular hexagonal cross-section. As such, the clips 116 may include a pair of legs having a generally irregular hexagonal space therebetween. The pair of legs of the clips 116 may grip opposing sides 121, 122 (FIG. 4) of the longitudinal mounting member 120 to hold the longitudinal mounting member 120 within the generally hexagonal space.

Referring also to FIGS. 4-5, illustrating various views of the windshield wiper 100. Particularly, FIG. 4 illustrates a side perspective view of the longitudinal mounting member 120, the first longitudinal flexible blade member 130, the second longitudinal flexible blade member 140 and the longitudinal scrubbing member 150, with the longitudinal scrubbing member 150 removed from in between the first and second longitudinal flexible blade members 130, 140 according to one or more embodiments of the present disclosure. FIG. 5 illustrates an exploded view of the longitudinal mounting member 120, the first longitudinal flexible blade member 130, the second longitudinal flexible blade member 140 and the longitudinal scrubbing member 150, according to one or more embodiments of the present disclosure.

As shown in FIGS. 4-5, a longitudinal channel 141 may be defined between the first longitudinal flexible blade member 130 and the second longitudinal flexible blade member 140. In this embodiment, the longitudinal scrubbing member 150 may be sized for placement in the longitudinal channel 141 and oriented parallel therewith.

As shown in these figures, the longitudinal scrubbing member 150 may include a length substantially equal to a length of the first longitudinal flexible blade member 130 and the second longitudinal flexible blade member 140. Further, the longitudinal scrubbing member 150 may include a height at least equal to a height of the first longitudinal flexible blade member 130 and the second longitudinal flexible blade member 140. In other words, in some embodiments, the longitudinal scrubbing member 150 may or may not extend past the tips 145a, 145b of the first longitudinal flexible blade member 130 and the second longitudinal flexible blade member 140; or in other embodiments, the longitudinal scrubbing member 150 may extend to the tips 145a, 145b of the first longitudinal flexible blade member 130 and the second longitudinal flexible blade member 140.

Further, as also shown here, the longitudinal scrubbing member 150 may include a width greater than a width of the first longitudinal flexible blade member 130 and the second longitudinal flexible blade member 140. This may enable the longitudinal scrubbing member 150 to encompass a wider surface area of the windshield 5 than the first and second longitudinal flexible blade members 130, 140 and enable removal of larger patches of debris, such as (as discussed above) insect residue.

As shown in FIGS. 4-5, in some embodiments, the first longitudinal flexible blade member 130 may be attached to and extending downwardly from the longitudinal mounting member 120 at a first side 121 of the longitudinal mounting member 120 and parallel therewith and the second longitudinal flexible blade member 140 may be attached to and extending downwardly from the longitudinal mounting member 120 at a second side 122 of the longitudinal mounting member 120 and parallel therewith.

As shown here, the first longitudinal flexible blade member 130 and the second longitudinal flexible blade member 140 may be connected together at a planar top 142a, 142b thereof. In some embodiments, the first and second longitudinal flexible blade members 130, 140 may be two separate pieces. In other embodiments, the first and second longitudinal flexible blade members 130, 140 may be one unitary piece.

Further, in some embodiments, the longitudinal mounting member 120, the first longitudinal flexible blade member 130 and the second longitudinal flexible blade member 140 may be made from a flexible material, such as rubber, silicone, or the like. In some embodiments, the longitudinal mounting member 120, the first longitudinal flexible blade member 130, the second longitudinal flexible blade member 140 may be permanently fixed together and may be provided as a refill for the windshield wiper 100.

In other embodiments, the longitudinal mounting member 120 may not be permanently attached to the first longitudinal flexible blade member 130 and the second longitudinal flexible blade member 140. For example, the longitudinal mounting member 120 may be provided separately and the first and second longitudinal flexible blade members 130, 140 may be provided as a refill for the windshield wiper 100 and including a removable longitudinal scrubbing member 150.

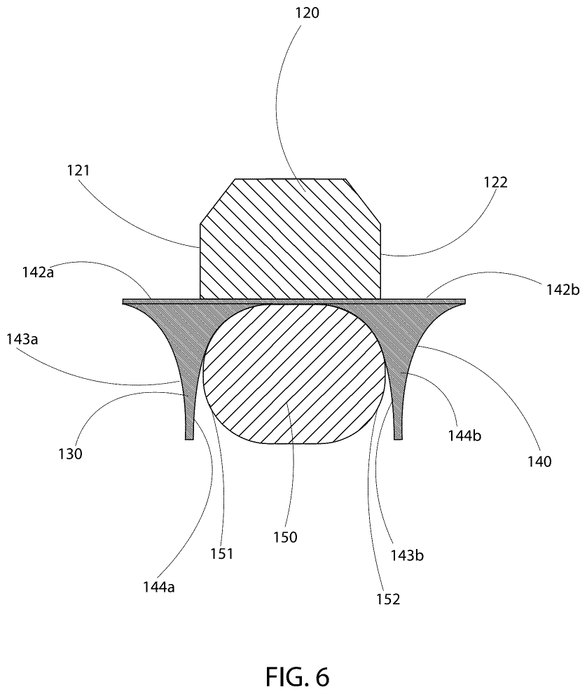

Referring now also to FIG. 6, illustrating a cross-section taken from line 6-6 in FIG. 3, according to one or more embodiments of the present disclosure. As shown here, the first longitudinal flexible blade member 130 and the second longitudinal flexible blade member 130 may each include a generally triangular cross-section. In particular, the first longitudinal flexible blade member 130 and the second longitudinal flexible blade member 130 may each include a planar top 142a, 142b, respectively, a curved blade member first side 143a, 143b, respectively, opposite a curved blade member second side 144a, 144b, respectively, that each taper into the tip 145a, 145b, respectively, for squeegeeing the windshield 5.

Further, in some embodiments, the longitudinal scrubbing member 150 may include an oval, oblong, or ellipsis shaped cross-section; again, as above, enabling the longitudinal scrubbing member 150 to scrub a larger surface area of the windshield 5 than the first and second longitudinal flexible blade members 130, 140. In particular, the longitudinal scrubbing member 150 may include a curved scrubbing member first side 151 opposite a curved scrubbing member second side 152 and a curved scrubbing member top side 153 opposite a curved scrubbing member bottom side 154. As shown in FIG. 5, the curved scrubbing member first side 151 may conform to an inner surface of the curved blade member second side 144a of the first longitudinal flexible blade member 130, and the curved scrubbing member second side 152 may conform to an inner surface of the curved blade member first side 143b of the second longitudinal flexible blade member 140.

The longitudinal scrubbing member 150 may be particularly used for scrubbing stuck-on debris, such as insects, from the windshield 5. To aid in this, the longitudinal scrubbing member 150 may include a textured outer surface 155. For example, the textured outer surface 155 may include mesh that enables scrubbing of the windshield 5. It should however be appreciated that the longitudinal scrubbing member 150 is not limited to the removal of solid or stuck-on debris, such as insects, from the windshield 5. For example, the longitudinal scrubbing member 150 may be useful in the removal of some liquid or semi-liquid debris. It is contemplated that the longitudinal scrubbing member 150 is particularly useful in the removal of debris having higher viscosity and higher adherence properties.

Further, in some embodiments, the longitudinal scrubbing member 150 may be constructed from rubber. However, it should be appreciated that the longitudinal scrubbing member 150 is not limited to rubber, nor a mesh outer surface. For example, the longitudinal scrubbing member 150 may include (but again is not limited to) a sponge having a coarse textured outer surface. As demonstrated in FIG. 4, in some embodiments, the longitudinal scrubbing member 150 may be removable from the longitudinal channel 141, enabling the longitudinal scrubbing member 150 to be replaced once the textured outer surface 155 is worn down, etc.

It should also be noted that, under appropriate circumstances, considering such issues as design preference, user preferences, marketing preferences, cost, structural requirements, available materials, technological advances, etc., other methods are taught herein.

It should be understood by one of skill in the art that the disclosed invention is described here in a few exemplary embodiments of many. No particular terminology or description should be considered limiting on the disclosure or the scope of any claims issuing therefrom.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the relevant patent offices and the public generally, and especially the scientist, engineers and practitioners in the art who are not familiar with patent or legal terms or phraseology, to determine quickly from a cursory inspection the nature and essence of the technical disclosure of the application.

1. A windshield wiper comprising:
a wiper arm mount including at least one arm mounting member attached at a top side of the wiper arm mount and at least one blade mounting member attached at a bottom side of the wiper arm mount, the at least one arm mounting member configured to attach the wiper arm mount to a wiper arm of a windshield;
a longitudinal mounting member configured to attach to the wiper arm mount via the at least one blade mounting member;
first and second longitudinal flexible blade members extending downwardly from respective sides of the longitudinal mounting member and together operative to remove loose debris from the windshield, wherein a longitudinal channel is defined between the first and second longitudinal flexible blade members; and
a longitudinal scrubbing member sized for placement in the longitudinal channel between the first and second longitudinal flexible blade members and oriented parallel therewith, the longitudinal scrubbing member operative to remove stuck-on debris from the windshield.

2. The windshield wiper of claim 1, wherein the first longitudinal flexible blade member and the second longitudinal flexible blade member each include a generally triangular cross-section.

3. The windshield wiper of claim 2, wherein the first longitudinal flexible blade member and the second longitudinal flexible blade member each include a planar top side and a curved blade member first side opposite a curved blade member second side, the curved blade member first side and the curved blade member second side of each of the first and second longitudinal flexible blade member each tapering into a tip for squeegeeing the loose debris from the windshield.

4. The windshield wiper of claim 3, wherein the first longitudinal flexible blade member and the second longitudinal flexible blade member are connected together at each planar top side.

5. The windshield wiper of claim 4, wherein the longitudinal mounting member, the first longitudinal flexible blade member and the second longitudinal flexible blade member are made from rubber.

6. The windshield wiper of claim 5, wherein the longitudinal scrubbing member includes a length substantially equal to a length of the first longitudinal flexible blade member and the second longitudinal flexible blade member.

7. The windshield wiper of claim 6, wherein the longitudinal scrubbing member includes a height at least equal to a height of the first longitudinal flexible blade member and the second longitudinal flexible blade member.

8. The windshield wiper of claim 7, wherein the longitudinal scrubbing member includes a width greater than a width of the first longitudinal flexible blade member and the longitudinal flexible blade member.

9. The windshield wiper of claim 8, wherein the longitudinal scrubbing member includes an oval cross-section and includes a curved scrubbing member first side opposite a curved scrubbing member second side and a curved scrubbing member top side opposite a curved scrubbing member bottom side.

10. The windshield wiper of claim 9, wherein the curved scrubbing member first side conforms to an inner surface of the curved blade member second side of the first longitudinal flexible blade member, and wherein the curved scrubbing member second side conforms to an inner surface of the curved blade member first side of the second longitudinal flexible blade member.

11. The windshield wiper of claim 10, wherein the longitudinal scrubbing member includes a textured outer surface.

12. The windshield wiper of claim 11, wherein the textured outer surface includes mesh.

13. The windshield wiper of claim 12, wherein the longitudinal scrubbing member is made from rubber.

14. The windshield wiper of claim 13, wherein the at least one blade mounting member includes a plurality of mounting members spaced apart along a length of the wiper arm mount.

15. The windshield wiper of claim 14, wherein the plurality of mounting members include clips configured to grip the longitudinal mounting member.

16. A windshield wiper comprising:
a wiper arm mount including at least one arm mounting member attached at a top side of the wiper arm mount and at least one blade mounting member attached at a bottom side of the wiper arm mount, the at least one arm mounting member configured to attach the wiper arm mount to a wiper arm of a windshield;
a longitudinal mounting member configured to attach to the wiper arm mount via the at least one blade mounting member;
a first longitudinal flexible blade member attached to and extending downwardly from the longitudinal mounting member at a first side thereof;
a second longitudinal flexible blade member attached to and extending downwardly from the longitudinal mounting member at a second side thereof and parallel with the first longitudinal flexible blade member, the first longitudinal flexible blade member and the second longitudinal flexible blade member defining a longitudinal channel therebetween, the first longitudinal flexible blade member and the second longitudinal flexible blade member together operative to remove loose debris from the windshield; and
a longitudinal scrubbing member sized for placement in the longitudinal channel between the first flexible blade member and the second flexible blade member and oriented parallel therewith, a width of the longitudinal scrubbing member being greater than a width of each of the first longitudinal flexible blade member and the longitudinal flexible blade member, and wherein longitudinal scrubbing member includes a textured mesh outer surface operative to remove stuck-on debris from the windshield.

17. The windshield wiper of claim 16, wherein the first longitudinal flexible blade member and the second longitudinal flexible blade member each include a generally triangular cross-section, the first longitudinal flexible blade member and the second longitudinal flexible blade member each including a planar top side and a curved blade member first side opposite a curved blade member second side, the curved blade member first side and the curved blade member second side of each of the first longitudinal flexible blade member and the second longitudinal flexible blade member each tapering into a tip for squeegeeing the loose debris from the windshield.

18. The windshield wiper of claim 17, wherein the longitudinal scrubbing member includes an oval cross-section and includes a curved scrubbing member first side opposite a curved scrubbing member second side and a curved scrubbing member top side opposite a curved scrubbing member bottom side, wherein the curved scrubbing member first side conforms to an inner surface of the curved blade member second side of the first longitudinal flexible blade member, and wherein the curved scrubbing member second side conforms to an inner surface of the curved blade member first side of the second longitudinal flexible blade member.

19. The windshield wiper of claim 18, wherein the longitudinal scrubbing member includes a length substantially equal to a length of the first longitudinal flexible blade member and the second longitudinal flexible blade member, and wherein the longitudinal scrubbing member includes and a height at least equal to a height of the first longitudinal flexible blade member and the second longitudinal flexible blade member.

20. A windshield wiper refill comprising:
a longitudinal mounting member configured to attach to a wiper arm mount;
first and second longitudinal flexible blade members extending downwardly from respective sides of the longitudinal mounting member, each of the first and second longitudinal flexible blade members including a planar top side, a curved blade member first side opposite a curved blade member second side and each tapering into a tip for removing loose debris from a windshield, wherein a longitudinal channel is defined between the curved blade member second side of the first longitudinal flexible blade member and the curved blade member first side of the second longitudinal flexible blade member; and
a longitudinal scrubbing member sized for removable placement in the longitudinal channel between the first flexible blade member and the second flexible blade member and oriented parallel therewith, a width of the longitudinal scrubbing member greater than a width of the first and second longitudinal flexible blade members, the longitudinal scrubbing member including a curved scrubbing member first side able to conform to an inner surface of the curved blade member second side of the first longitudinal flexible blade member, and a curved scrubbing member second side able to conform to an inner surface of the curved blade member first side of the second longitudinal flexible blade, the longitudinal scrubbing member further including a textured mesh outer surface operative to remove stuck-on debris from the windshield.
